(19) United States
(12) Patent Application Publication
(10) Pub. No.: US 2008/0061531 A1
(43) Pub. Date: Mar. 13, 2008

(54) Transporting apparatus

(76) Inventor: Paul J. Nugent, Fresno, CA (US)

Correspondence Address: Rodney K. Worrel;WORREL & WORREL, St. Croix Professional Center, 2109 W. Bullard Avenue, Suite 121, Fresno, CA, 93711-1258, US

(21) Appl. No.: 11/518,338

(22) Filed: Sep. 7, 2006

(51) Int. Cl. B62B 1/00

(52) U.S. Cl. 280/638

(57) ABSTRACT

An apparatus for transporting a work object into a selected position, the apparatus having a frame; a container mounted on the frame for receiving a work object in supported relation; and at least one leg member assembly borne by the frame for movement between a transporting position, in which the work object can be moved into a secondary position adjacent to the selected position, and a retracted position, in which the work object can be moved into the selected position.

### CROSS-REFERENCE TO RELATED APPLICATIONS

Not applicable.

### STATEMENT REGARDING FEDERALLY SPONSORED RESEARCH OR DEVELOPMENT

Not Applicable.

### BACKGROUND OF THE INVENTION

(1) Field of the Invention

The present invention relates to a transporting apparatus and, more particularly, to a transporting apparatus which is uniquely well suited to moving work objects of a plurality of different types from one location to another with an ease and proficiency not heretofore achieved in the art.

(2) Description of the Prior Art

A wide variety of environments exist in which work objects are to be moved from one location to another. Typically, the work objects must be on-loaded at a first location, transported over a distance to a second location and finally off-loaded at the second location. Where there are many such work objects, this operation can be labor intensive, time consuming and tedious. Where the work objects are heavy, the process of lifting, carrying and placing the work objects in the second location can be exhausting and can cause muscular strain or injury. The on-loading operation at the first location may present less difficulty because of the available assistance of others at the first location and/or the use of mechanical devices, such as conveyer belts.

One such environment, illustrative of all of the foregoing circumstances, is that encountered in grocery and other types of shopping at stores or other business outlets. The commodities which have been purchased must typically be loaded into a shopping cart, wheeled to a secondary location and then unloaded at the secondary location. The secondary location is, typically, an automotive vehicle having a storage area accessible from the back. A similar environment is encountered in businesses and other facilities where supplies, or other work objects, must be transferred internally within the business from one location to another. Frequently, the second, or receiving, location has a work table, counter or similar support surface on which the objects are to be placed.

Still another environment possessing similar considerations is that in which luggage, bags, or the like are to be loaded into a vehicle for transport to an airport, or to a train or bus station. In other instances such items must be loaded into the back of a vehicle simply for travel to another location, such as in the case of an outing or a vacation.

There are still other environments in which the same, or similar, considerations must be taken into account. In demolition and construction operations and the like it is common to require the removal of waste materials, such as broken concrete, large pieces of wood and sheet rock, fragments of other waste materials such as conduit, electrical wire, fasteners, tree limbs, trash, and the like. At the time for disposal of such waste materials, the materials are typically loaded into the back of a vehicle for transport to a disposal site.

In many cases there may only be one person available to perform these tasks. The difficulty encountered by that one person subjects the person to all of the possible adverse consequences heretofore set forth. Where the capacity of the person is limited in someway, such as in the case of a preexisting injury, these difficulties may be insurmountable, or, at very least, require the assistance of one or more other persons, when available, to achieve the desired result.

These and other possible circumstances in such environments can be perplexing and certainly can impede the job to be performed.

Therefore, it has long been known that it would be desirable to have an apparatus which was operable to assist in the movement of work objects from a first location to a second location; which was adapted readily to transfer the work objects at the second location; which can be operated by a single person with very little effort and while minimizing the possibility of strain or injury; which can be manufactured at nominal cost so as to be practical for usage in a wide variety of operational environments; and which is otherwise entirely successful in achieving its operational objectives.

### BRIEF SUMMARY OF THE INVENTION

Therefore, it is an object of the present invention to provide an improved transporting apparatus which is particularly well suited to the transport of work objects from a first location to a second location.

Another object is to provide such a transporting apparatus which is adaptable for use is a wide variety of operational environments.

Another object is to provide such a transporting apparatus which facilitates the movement of work objects in such a manner as to avoid risk of strain or injury to the person operating the transporting apparatus.

Another object is to provide such a transporting apparatus which is particularly well suited to the transfer of the work objects from a first location to a second location and which is readily operable to achieve the transfer of the work objects at the second location.

Another object is to provide such a transporting apparatus which can readily interoperate with a wide variety of conventional equipment to achieve the objectives of the operator.

Another object is to provide such a transporting apparatus which is operable, under the control of the operator, to assume a number of sequential configurations in the performance of its task so as to facilitate the operation to be performed.

Another object is to provide such a transporting apparatus which can be constructed in a variety of different configurations best suited to the specific work environment in which it is to be employed.

Another object is to provide such a transporting apparatus which is particularly well suited to the transport and transfer of a plurality of distinct objects, such as groceries or other commodities, from a first collection location, such as a store, to a second, or receiving, location, such as an automotive vehicle.

Another object is to provide such a transporting apparatus which can be disposed in a stowed configuration when not in use and which can promptly be disposed in an operational configuration so as to be immediately available for use when desired.

Further objects and advantages are to provide improved elements and arrangements thereof in an apparatus for the purpose described which is dependable, economical, durable and fully effective in accomplishing its intended purposes.

These and other objects and advantages are achieved in the transporting apparatus of the present invention which is operable to transport a work object into a selected position with an ease and proficiency not heretofore achieved in the art; which is capable of being used to transport work objects, such as groceries and other commodities, from a first location into a vehicle, to transport the work objects in the vehicle to a second location and to permit unloading of the work objects in the second location all substantially without handling of the work objects; which is capable of being manufactured in a variety of different embodiments well suited to a variety of different environments; which is adapted for use substantially avoiding the risk of strain or injury from such usage; and which can be disposed in a stowed configuration while being promptly available for use in an operational configuration when desired.

### BRIEF DESCRIPTION OF THE SEVERAL VIEWS OF THE DRAWINGS

FIG. 1 is a three quarter view of the transporting apparatus of the present invention viewed from the right side thereof.

FIG. 2 is a three quarter view of the transporting apparatus of FIG. 1 viewed from the left side thereof.

FIG. 3 is a three quarter view of the transporting apparatus of FIG. 1 viewed from the top thereof and showing the transporting apparatus in a partially collapsed configuration.

FIG. 4 is a three quarter view of the transporting apparatus of FIG. 1 viewed from the bottom thereof and showing the transporting apparatus in the partially collapsed configuration shown in FIG. 3.

FIG. 5 is a fragmentary side elevation showing the transporting apparatus of FIG. 1 in a representative operative environment used in the transfer of work objects, such as groceries, from the transporting apparatus to the rear storage area of an automotive vehicle, showing the storage area in phantom lines therewithin and the transporting apparatus in one operational configuration.

FIG. 6 is a somewhat enlarged fragmentary side elevation of the automotive vehicle of FIG. 5 showing the transporting apparatus of FIG. 1 in phantom lines in the partially collapsed configuration shown in FIG. 3 and fully received within the storage area of the automotive vehicle.

FIG. 7 is a three quarter view of the transporting apparatus of the present invention shown from the right side thereof and in a fully collapsed configuration.

FIG. 8 is a fragmentary side elevation of the automotive vehicle of FIGS. 5 and 6 showing the transporting apparatus in full lines in an intermediate configuration and in phantom lines in a fully collapsed configuration fully received within the storage area of the automotive vehicle.

### DETAILED DESCRIPTION OF THE INVENTION

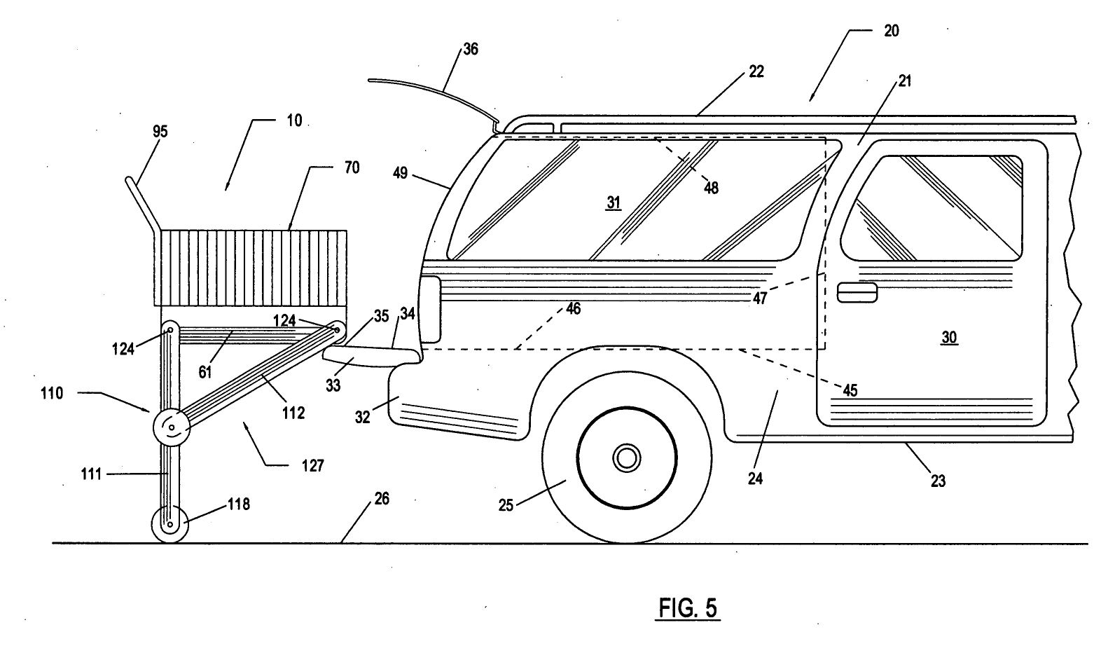

Referring more particularly to the drawings, the transporting apparatus of the present invention is generally indicated by the numeral 10 in FIG. 1. The transporting apparatus can be employed in a wide variety of operative environments, as will hereinafter become more clearly apparent. One such operative environment is depicted in FIGS. 5, 6 and 8. This operative environment is shown and described herein merely for illustrative convenience in showing the structure and operation of the transporting apparatus.

As shown in FIGS. 5, 6 and 8, an automotive vehicle is generally indicated by the numeral 20. The vehicle is shown fragmentarily in these views having a vehicle body 21. The vehicle has, generally, a top 22 and a bottom 23. As visible in FIGS. 5, 6 and 8, the vehicle has a right side 24 and a right rear wheel 25 rested on a surface of support 26.

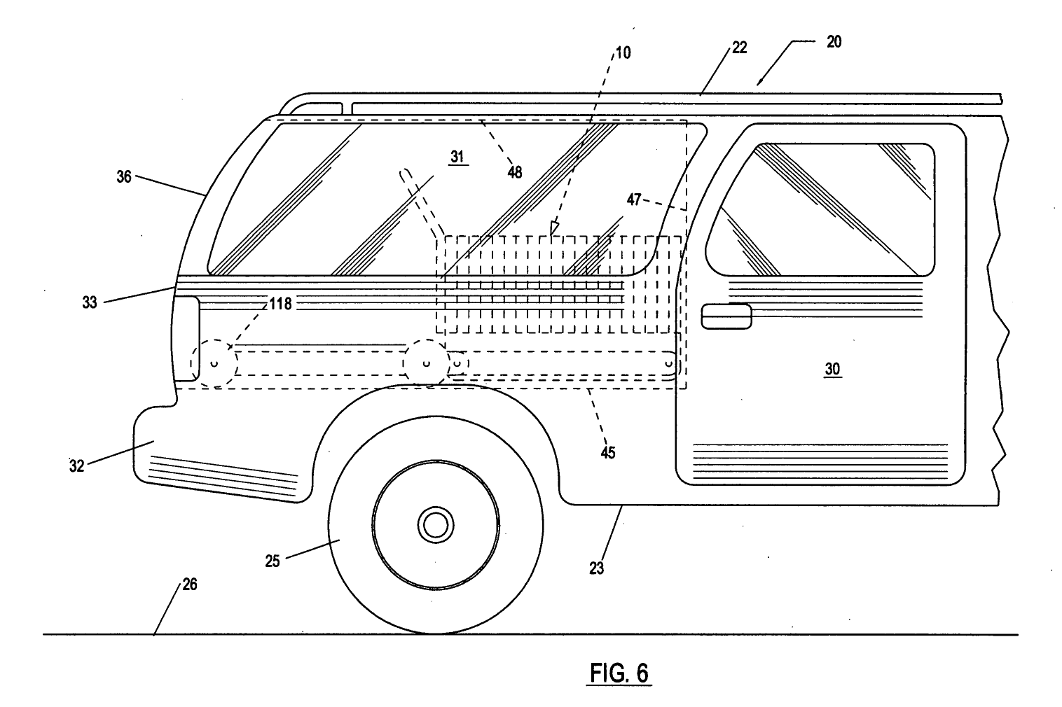

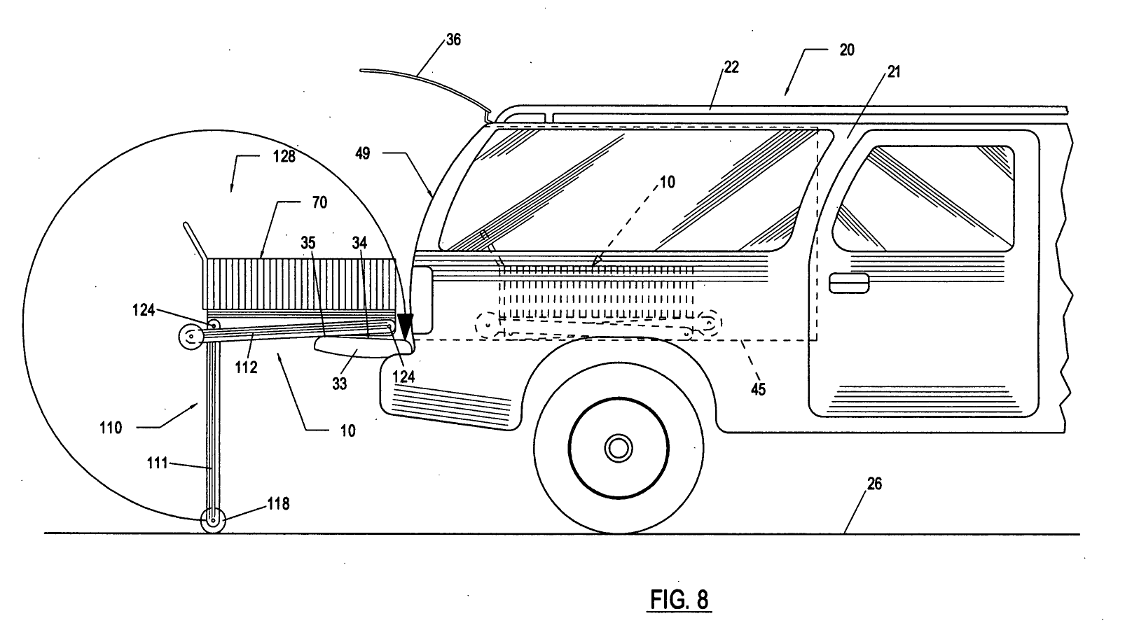

The vehicle has a right side door 30 and a right side window 31. The vehicle has a rear bumper 32 and a tailgate 33. The tailgate is movable between a lowered position, shown in FIGS. 5 and 8, and a raised position, shown in FIG. 6. The tailgate has an upper surface 34 having a distal or outer portion 35. The vehicle has a rear window 36 which is shown in a raised, or opened, position in FIGS. 5 and 8 and in a lowered, or closed, position in FIG. 6.

The automotive vehicle 20 has an internal storage compartment 45 which is shown in phantom lines in FIGS. 5, 6 and 8. The storage compartment has a substantially flat floor 46. The storage compartment extends to an interior wall 47 within the vehicle. The storage compartment is bounded upwardly by a substantially flat top wall 48. The floor 46 and top wall 48 are substantially parallel to each other. When the tailgate and rear window are in their respective opened positions, as shown in FIGS. 5 and 8, a rear opening 49 extends into the storage compartment of the vehicle in substantial alignment with the floor 46 and top wall 48 thereof.

It will be understood that the foregoing description of the vehicle 20 is included herein simply to assist in describing one environment of usage of the transporting apparatus 10 of the present invention. The specific automotive vehicle shown and described herein is employed only as representative of all vehicles of this general type. The transporting apparatus is not in anyway to be limited to the specific automotive vehicle 20 shown and described herein. Furthermore, it will become apparent that the transporting apparatus can be employed with the vehicle 20 in other modes of operation, with other types of vehicles and with receiving locations other than automotive vehicles.

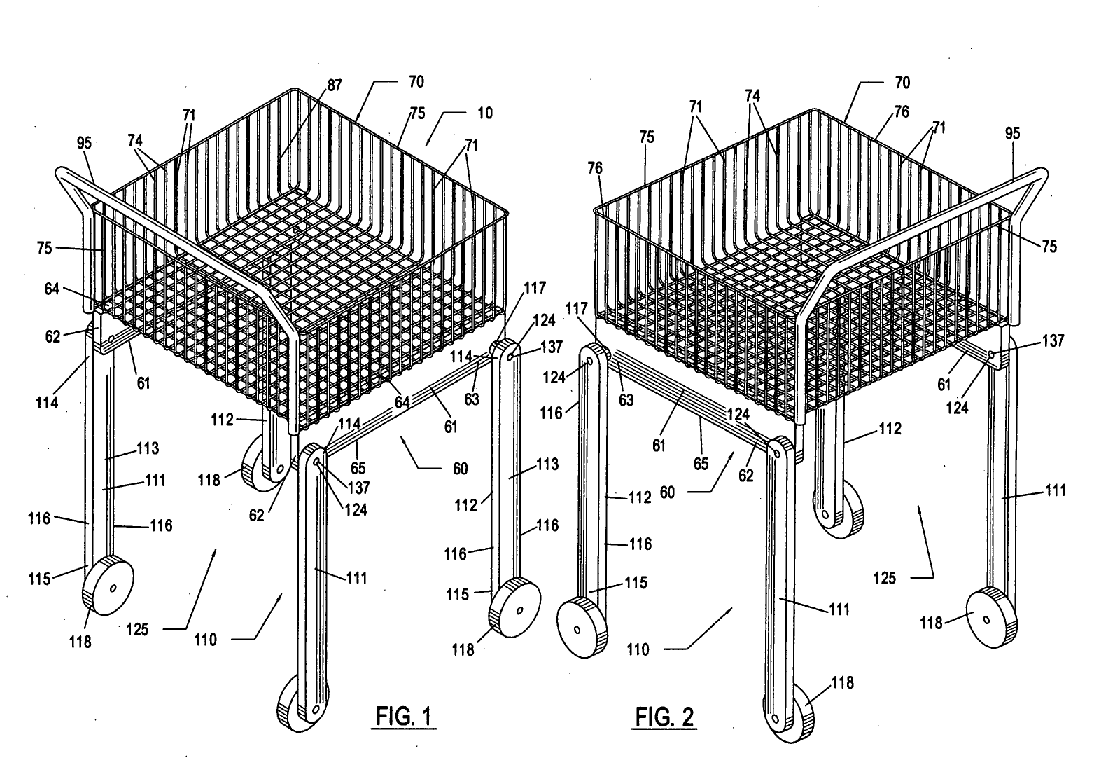

Referring more particularly to FIGS. 1 and 2, the transporting apparatus 10 of the subject invention has a main frame generally indicated by the numeral 60. The main frame has a pair of parallel frame members 61 disposed in predetermined spaced, substantially parallel relation to each other. The frame members 61 are preferably constructed of metal, but can be constructed of any other suitable material, such as wood or plastic. Each of the frame members has a proximal end portion 62 and an opposite distal end portion 63. Each of the frame members has an upper surface 64 and a parallel lower surface 65. If desired for purposes of additional support, the frame members 61 can rigidly be interconnected by cross members, not shown, mounted on and extending between the frame members 61.

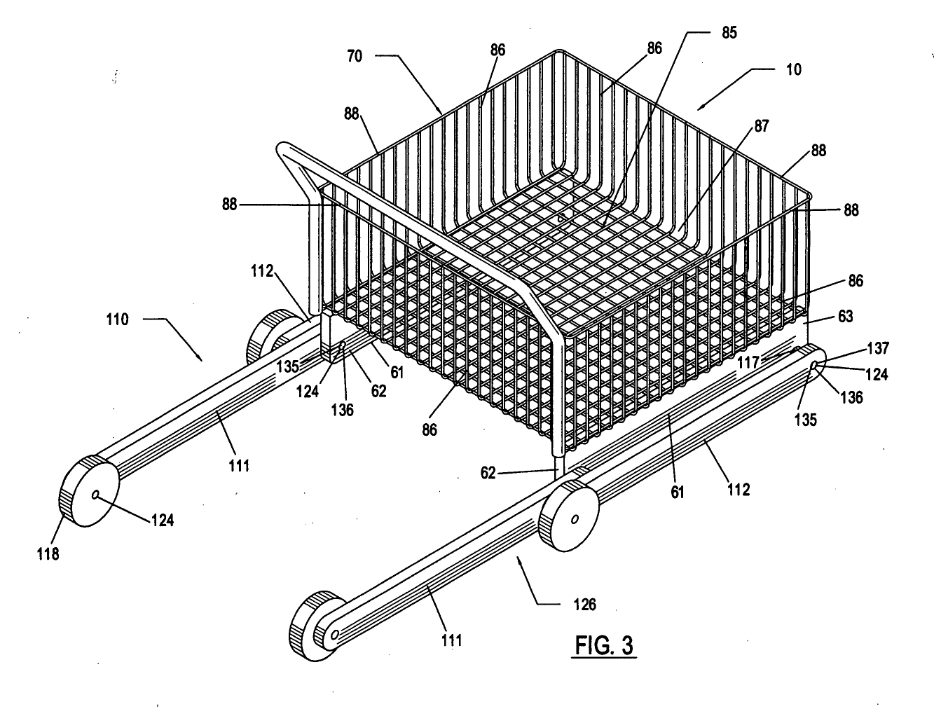

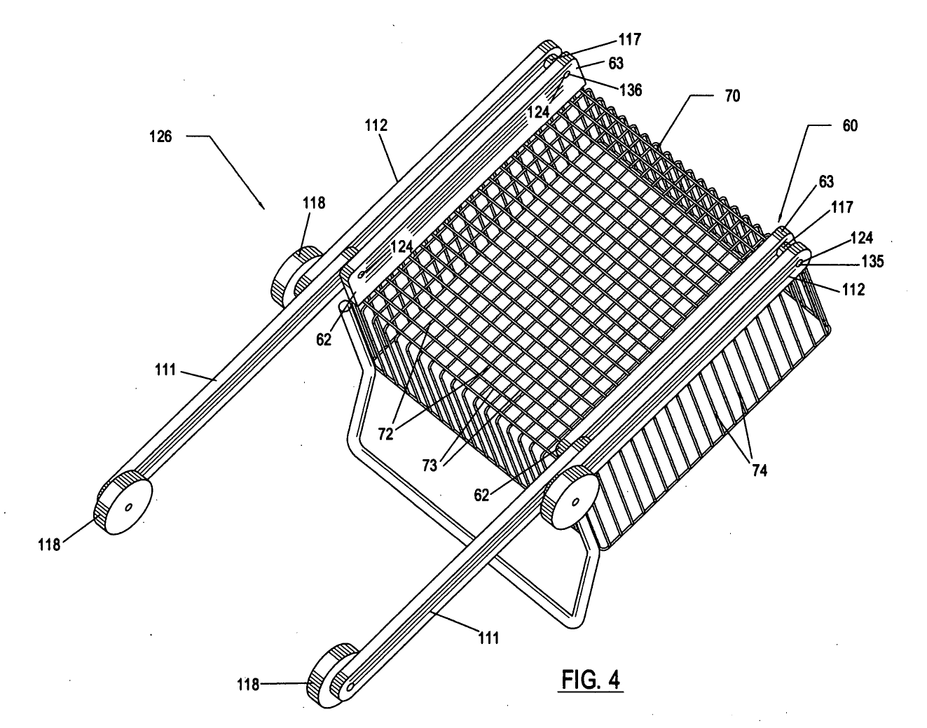

A container or basket assembly 70 is mounted on the upper surfaces 64 of the frame members 61. The basket assembly is preferably, although not necessarily, constructed of rigid metal wire members 71. The metal wire members are of sufficiently strong gauge that the basket assembly is capable of supporting substantial weight. As perhaps best shown in FIG. 4, the wire members include a plurality of substantially parallel longitudinal wire members 72. Similarly, the wire members 71 include a plurality of substantially parallel transverse wire members 73. As perhaps best shown in FIGS. 2 and 3, each of the wire members 72 and 73 is bent upwardly at right angles thereto at the opposite ends thereof to form upstanding end portions 74 which are substantially parallel to each other. The corresponding upstanding end portions 74 of the longitudinal wire members 72 are interconnected by parallel upper wire members 75. Similarly the corresponding upstanding end portions of the transverse wire members 73 are interconnected by the upper wire members 76.

The junctions of the longitudinal wire members 72, transverse wire members 73 and the upstanding end portions 74 with their respective upper wire members 75 and 76 are joined by any suitable means, such as by welding or the like. The basket assembly is mounted on the main frame of the transporting apparatus 10 by welding of the wire members 71 on the upper surfaces 64 of the frame members 61, or by any other suitable means such as fasteners of any suitable type. Where the frame members are constructed of a material other than metal, such as wood or plastic, any suitable fasteners can be employed securely to mount the basket assembly on the upper surfaces of the frame members 61 in fixed position, as shown in the drawings hereof.

Thus, the basket assembly 70 is rigid, but possesses a limited degree of flexibility. With reference to FIG. 3 and for illustrative convenience, the basket assembly can be viewed as having a floor 85 composed of the longitudinal and transverse wire members 72 and 73. Similarly, the basket assembly can be viewed as having four (4) upstanding end walls 86 composed of the upstanding end portions 74 of the longitudinal and transverse wire members 72 and 73. The floor 85 and end walls 86 define an internal compartment 87 of the basket assembly. The end walls 86 can each be viewed as having an upper lip or edge portion 88.

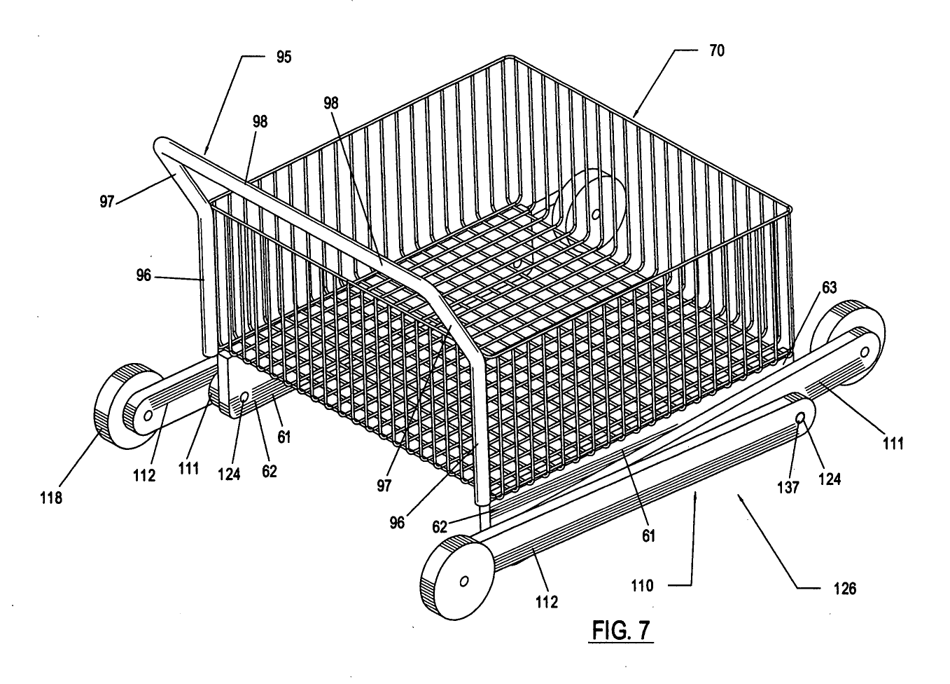

A handle assembly 95 is mounted on the basket assembly 70, as perhaps best shown in FIG. 7. The handle assembly has a pair of tubular members 96 individually mounted, as by welding, on the basket assembly at opposite ends of the upstanding end wall 86 adjacent to the proximal end portions 62 of the parallel frame members 61. The tubular members extend upwardly therefrom in spaced, substantially parallel relation to each other. Each of the tubular members 96 individually have upwardly sloped tubular members 97 contiguous therewith and interconnected at their upper extremities by a tubular handle 98 extending horizontally therebetween. The handle assembly is operable to push the transporting apparatus, as will hereinafter be described in greater detail.

A transporting assembly or mechanism 110 is mounted on the main frame 60 of the transporting apparatus 10. The transporting mechanism has two (2) rearward leg assemblies 111 individually mounted in corresponding positions on the frame members 61 adjacent to the proximal end portions 62 thereof. The transporting mechanism has two (2) forward leg assemblies 112 mounted in corresponding positions on the frame members 61 adjacent to the distal end portions 63 thereof. Each of the leg assemblies has a support member 113 having an upper end portion 114 and an opposite lower end portion 115. Each support member has opposite lateral surfaces 116 which are parallel to each other.

The upper end portion 114 of each support member 113 is mounted on the proximal or distal end portion 62 or 63 of each of the frame members 61. The support members are mounted in their respective positions on pivot pin assemblies 124 which interconnect the upper end portion 114 of each support member 113 and the frame members 61, as will hereinafter be described in greater detail. The support members 113 on the distal end portions 63 of each of the frame members 61 is spaced from the distal end portion 63 by a space 117 extending about its respective pivot pin assembly between the upper and portion of its respective pivot pin assembly and the distal end portion of its respective frame member 61. The lower end portion 115 of each support member 113 mounts a wheel assembly 118 rotationally thereon. The four (4) wheels thus support the transporting apparatus 10 for earth traversing movement.

Thus, as shown in FIGS. 1 and 2, four (4) support members 113 are mounted on the transporting apparatus 10. As shown in FIGS. 1 and 2, the support members are in down and locked positions 125, as will hereinafter be discussed in greater detail. As shown in FIGS. 3, 4 and 7 and in phantom lines FIGS. 6 and 8 the support members are in up and locked positions. As shown in FIG. 5 the transporting apparatus 10 is in a first intermediate configuration wherein the support members 113 mounted on the proximal end portions 62 of the frame members 61 are in the down and locked positions 125 and the support members 113 mounted on the distal end portions 63 of the frame members 61 not locked in place, but rather are free to pivot about their respective pivot pin assemblies 124. FIG. 8 shows the transporting apparatus in full lines in a second intermediate configuration 128 in which the front of the transporting apparatus 10 is rested on the outer portion 35 of the upper surface 34 of the tailgate 33 and all four (4) of the support members are unlocked and free to pivot about their respective pivot pin assemblies 124. As shown in FIG. 8 in phantom lines, the transporting apparatus is fully received within the storage compartment 45 of the automotive vehicle 20.

The pivot pin assemblies 124 can be of any suitable construction which permit the transporting apparatus 10 to be placed in all of the positions and configurations heretofore described and as shown in the drawings; that is, FIGS. 1 through 8.

The pivot pin assemblies 124, disclosed herein for illustrative convenience, have a pair of aligned passages 135 extending through the upper end portions 114 of the support members 113 and the respective proximal and distal end portions 62 and 63 of the frame members 61. A pivot shaft 136 extends through each pair of aligned passages of the respective pivot pin assemblies. A suitable lock and release mechanism 137 is mounted on each pivot shaft within the aligned passages 135. Each lock and release mechanism is operable in one fixed, selected position to prevent movement between its respective upper end portion 114 of its support member 113 and the respective proximal or distal end portion 62 or 63 of the frame member 61. This specific position is selected by the operator using the lock and release mechanism thereof. The possible selected positions include those heretofore described and shown in FIGS. 1, 2, 3, 4, 5, 6, 7 and 8.

Alternatively, at the selection of the operator, each lock and release mechanism 137 can selectively be operated by the operator to place it in a pivotal selected position permitting pivotal movement between its respective upper end portion 114 of the support member 113 and the proximal or distal end portion 62 or 63 of the frame member 61. Once the desired selected position is reached, the lock and release mechanism can either be left in the setting still permitting such pivotal movement, or locked to retain the support member 113 in the selected position chosen. Selected locked positions of the support members 113 are shown in FIGS. 1 and 2. As shown in FIGS. 3, 4, 7, and in phantom lines in FIGS. 6 and 8, each lock and release mechanism can selectively be operated to permit such pivotal movement of its respective support member or operated to lock it in position. As shown in FIG. 5, the front support members 113 are retained in their pivotal settings while the rearward support members are set in their respective down and locked positions 125 thus assuming the first intermediate configuration 127. As shown in FIG. 8, all of the support members are left in their respective pivotal positions and assuming the second intermediate configuration 128.

Other types of lock and release mechanisms which can be used instead of the lock and release mechanism 137 are, for example, detent and ball or pin construction. A racket mechanism capable of locking or releasing the respective support members 113 or the like can also be used.

### Operation

The operation of the described embodiment of the subject invention is believed to be clearly apparent and is briefly summarized at this point.

As shown in FIGS. 1 and 2, the transporting apparatus 10 is disposed in a configuration in which it is used to receive work objects to be transported from a first location to a second location. As previously noted, the support members 113 are in the down and locked positions 125 with the wheel assemblies 118 in engagement with the surface of support 26, such as a paved surface, for earth traversing movement. The internal compartment 87 is disposed to receive work objects, such as groceries, or other products, in supported relation therewithin. In the illustrative example hereof, the transporting apparatus will thus be in what is considered a first location. Specifically, for example the first location could be inside a store at a checkout counter. The work objects, in this case groceries or other commodities, are placed in the internal compartment 87 of the transporting apparatus 10 by personnel within the store.

The operator then pushes the transporting apparatus 10 on its wheel assemblies 118 across the surface of support 26, specifically a parking lot or the like, to the rear of the automotive vehicle 20. The operator, of course, pushes the transporting apparatus using the handle assembly 95. The transporting apparatus is guided toward the rear of the automotive vehicle also using the handle assembly 95 thereof.

When the operator has reached the automotive vehicle 20 with the transporting apparatus 10, he or she simply unlocks the rear of the automotive vehicle in the conventional manner, such as by using the appropriate key. The operator then lowers the tailgate 33 to the position shown in FIGS. 5 and 8. In addition, the operator raises the rear window 36 to the position shown in FIGS. 5 and 8. Thus, the rear opening 49 leading to the storage compartment 45 is fully opened and available for use.

At this time, the operator, pushes the distal end portions 63 of the frame members 61 to a rested position of the outer portion 35 of the tailgate 33. Using the pivot pin assemblies 124 of the forward support members 113, the forward support members 113 are released for pivotal movement of the support members about their respective pivot shafts 136. This frees the forward support members 113 for pivotal movement to the position shown in FIG. 5. At the same time the rear support members 113 are in the down and locked positions shown in FIG. 5 thereby supporting the rear of the transporting apparatus while the front of the transporting apparatus is supported by resting on the tailgate 33, as shown in FIG. 5.

The operator then pushes the transporting apparatus 10 farther into the storage compartment 45 of the automotive vehicle 20 causing the forward support members 113 to continue to be pivoted upwardly to the positions shown in FIG. 8. The operator continues to push the transporting apparatus 10 until all of the weight of the transporting apparatus is borne by the tailgate 33 and, where pushed far enough, the floor 46 of the storage compartment 45.

The operator thereafter releases the rear support members 113 for pivotal movement about their respective pivot shafts 136 again using the pivot pin assemblies 124. The rear support members are then free to be pivoted in a clockwise direction, as shown in FIG. 8, to the fully collapsed configurations shown in FIG. 7 and its phantom lines in FIG. 8. Where the fully collapsed configuration has been achieved, the transporting apparatus 10 can simply be pushed farther forwardly on the floor 46 of the storage compartment 45 to clear the rear opening 49 for closing of the tailgate 33 and rear window 36. The transporting apparatus 10 is thus fully received within the storage compartment 45 and in the fully collapsed configuration, as shown in phantom lines in FIG. 8. At this time, the groceries or other work objects in the internal compartment 87 of the transporting apparatus are left in place and have thus been transferred into the automotive vehicle without any handling whatsoever.

Alternatively, when the transporting apparatus 10 has been placed in the configuration in which all of its weight is supported on the tailgate 33 and the floor 46 of the storage compartment 45 and all four (4) of the support members 113 released for pivotal movement using their respective pivot pin assemblies 124, the transporting apparatus can simply be pushed forwardly until it is fully received in the storage compartment 45. Where this is done, the transporting apparatus is thus placed in the configuration shown if FIGS. 3 and 6.

Where the operator, driving the automotive vehicle 20, reaches his or her destination, such as the operator's home, the groceries or work objects are still fully contained in the internal compartment 87 of the transporting apparatus. In order to remove the transporting apparatus with the work objects borne thereby, the tailgate 33 and rear window 36 are again moved to their respective open positions shown in FIGS. 5 and 8. Using the handle assembly 95, the transporting apparatus is pulled toward rear opening 49 along the floor 46 of the storage compartment 45.

Where the transporting apparatus 10 is in the configuration shown in phantom lines in FIG. 8 and in full lines in FIG. 7, the transporting apparatus is pulled from the rear opening 49 of the storage compartment 45. As the transporting apparatus continues to be pulled through the rear opening, the rear support members 113 pivot downwardly upon coming free of the tailgate. The lock and release assemblies of these support members are used to lock the rear support members 113 in the down and locked positions shown in FIG. 8.

Where the transporting apparatus 10 is in the configuration in the storage compartment 45 of the vehicle 20 as shown in FIG. 3 and in phantom lines in FIG. 6, the same procedure described above is employed. In this case, however, the rear support members 113 exit the rear opening 49 of the vehicle 20 and pivot downwardly to assume the down and locked position 125 shown in FIG. 5. The front support members 113 thereafter exit the rear opening 49 of the vehicle and pivot downwardly to assume the down and locked positions shown in FIGS. 1 and 2. The pivot pin assemblies are used to lock the support members in their respective down and locked positions to assume the configuration shown in FIGS. 1 and 2.

The transporting apparatus 10 can then be used to transport the groceries, or other work objects contained in the internal compartment 87, to any desired location, such as a home, for unloading of the work objects. Depending upon the particular structure and arrangement of the location where the unloading operation is to take place, the procedures heretofore described for such unloading can be used as appropriate.

In addition to all of the foregoing objects and advantages, the transporting apparatus can be left in place in the storage compartment for use when needed. Still further, it will be seen that automotive vehicles, when new, can come equipped with a transporting apparatus 10 in the storage compartment 45 of the vehicle. Alternatively, the transporting apparatus can be sold as an option at the time of sale of a new vehicle, or as an after market product.

Additional versatility of the transporting apparatus 10 exists in its ability to be operated in the same manner as heretofore described, but in other locations on vehicles or on other types of vehicles. For example, the transporting apparatus can be used in the same manner to place work objects borne thereby on the back seat, or passenger seat of the automotive vehicle by using the same steps heretofore described.

These and other objects and advantages are achieved in the apparatus of the present invention which is operable to transport a work object into a selected position with an ease and proficiency not heretofore achieved in the art; which is capable of being used to transport work objects, such as groceries and other commodities, from a first location into a vehicle, transport the work objects in the vehicle to a second location and unload the work objects in the second location substantially without handling the work objects; which is capable of being manufactured in a variety of different embodiments well suited to a variety of different environments; which is adapted for use substantially avoiding the risk of strain or injury to the operator from such usage; and which can be disposed in a stowed configuration while being promptly available for use in an operational configuration when desired.

Although the invention has been herein shown and described in what is conceived to be the most practical and preferred embodiment, it is recognized that departures may be made therefrom within the scope of the invention which is not to be limited to the illustrative details disclosed.

Having described my invention, what I claim as new and desire to secure by Letters Patent is:

1. An apparatus for transporting a work object into a predetermined position, the apparatus comprising a frame; means mounted on the frame for receiving a work object in supported relation; and at least one leg assembly borne by the frame for movement between a transporting position, in which the work object can be moved into a secondary position adjacent to said predetermined position, and a retracted position, in which the work object can be moved into said predetermined position.

2. The apparatus of claim 1 wherein said leg assembly is borne by the frame for substantially pivotal movement between the transporting position and the retracted position.

3. The apparatus of claim 2 in which said predetermined position has a means of support and wherein the apparatus can be moved toward said predetermined position to cause said leg assembly to engage said means of support to pivot the leg assembly toward said retracted position and the frame bearing the work object to be moved onto the means of support.

4. The apparatus of claim 3 wherein four leg assemblies are pivotally mounted on the frame, two leg assemblies of which are mounted forwardly on the frame and two leg assemblies of which are mounted rearwardly on the frame, whereby movement of the frame from the secondary position toward said predetermined position causes said leg assemblies to engage the means of support and the leg assemblies to be moved through a sequence of positions resulting in the frame being moved into said predetermined position and thereby the work object into said predetermined position.

5. The apparatus of claim 4 wherein each leg assembly is mounted on said frame on a shaft selectively engageable for fixing the leg assembly on its respective shaft and thereby to lock said leg assembly in a selected position relative to the frame.

6. The apparatus of claim 4 wherein said two leg assemblies which are mounted forwardly on the frame are pivoted from said transporting position toward said retracted position by engagement with said means having said means of support.

7. The apparatus of claim 4 in which said means of support having said predetermined position is in the rear of an automotive vehicle and said rear can selectively be opened to provide access to said predetermined position.

8. The apparatus of claim 4 wherein said four leg members are collapsible so that the apparatus can be stored in said predetermined position.

9. The apparatus of claim 8 wherein when the frame is in said predetermined position, the frame can be removed therefrom by pulling the frame from the predetermined position toward said secondary position until said leg members which are mounted forwardly on the frame gravitationally pivot downwardly to said transporting position and including means for releasably locking said leg members in the transporting position.

10. An apparatus for transporting work objects, such as commodities and the like, from a collection location into a receiving location without having to transfer the work objects from the apparatus at said receiving location, the apparatus comprising a rigid frame; a container mounted on the frame having an upwardly facing opening for receiving said work objects in supported relation within the container; a pair of forward leg assemblies, having lower end portions, mounted on the frame for substantially pivotal movement between substantially corresponding transporting and retracted positions; a pair of rearward leg assemblies, having lower end portions, mounted on the frame for substantially pivotal movement between substantially corresponding transporting and retracted positions; means mounted on the frame for releasably locking each individual leg assembly in said transporting and retracted positions and any selected position therebetween; and wheel assemblies individually mounted on the lower end portions of the forward and rearward leg assemblies for earth traversing movement of the apparatus when the leg assemblies are in the transporting positions whereby the apparatus can be moved from said collection location to said receiving location by engagement of the forward leg assemblies with the receiving location to pivot said forward leg assemblies toward the retracted position sufficiently upon continued movement of the apparatus to move said container into the receiving location.

11. The apparatus of claim 10 wherein the pair of forward leg assemblies and said pair of rearward leg assemblies in their respective retracted positions are collapsed relative to said container to permit the container to be stored in said receiving location.

12. The apparatus of claim 10 wherein said pair of forward leg assemblies are in their respective retracted positions and said pair of rearward leg assemblies are in their respective retracted positions the container can be pulled from the receiving location for usage by sequentially gravitationally pivoting the pair of rearward leg assemblies downwardly into their transporting positions and subsequently the pair of forward leg assemblies downwardly into their respective transporting positions and the container from the receiving location.

13. The apparatus of claim 12 wherein said means for releasably locking can be operated to lock their respective forward and rearward leg assemblies in said transporting positions to support the container for earth traversing movement.

14. The apparatus of claim 13 wherein a handle assembly is mounted on the apparatus for pushing to provide means for selectively moving the apparatus in said earth traversing movement.
